(19) United States
(12) Patent Application Publication
(10) Pub. No.: US 2003/0010345 A1
(43) Pub. Date: Jan. 16, 2003

(54) Patient monitoring devices and methods

(76) Inventors: Arthur Koblasz, Atlanta, GA (US); Mary Koblasz, Atlanta, GA (US); Robert S Mckeeman, Celebration, FL (US); Lorand Csiszar, Marietta, GA (US)

Correspondence Address: Jerry C Liu, Sutherland Asbill & Brennan, 999 Peachtree Street N E, Atlanta, GA, 30309-3996, US

(21) Appl. No.: 10/203,130

(22) PCT Filed: Feb. 2, 2001
(86) PCT No.: PCT/NZ01/00012

(51) Int. Cl. A61G 15/00

(52) U.S. Cl. 128/845

(57) ABSTRACT

The device features one or more video cameras (13, 14, 15) linked to a computer (16) which analyses the output of the cameras to distinguish between normal movement and falls. Upward or similar movements, normally associated with a patient attempting to get out of bed are also identified. An alarm is activated at a remote attendant station when a fall movement is determined to have occured. The cameras and computer are situated as a bedside unit (11).

### TECHNICAL FIELD

The invention pertains to patient monitoring and more particularly to methods and apparatus to detect, prevent and report falls, using video imaging technology or pressure sensitive mats.

### BACKGROUND

Falls are a serious health problem for elderly people. Elderly adults surveyed in the US and in England both claimed that approximately 33% had one or more falls in the past twelve months and 25% of these falls resulted in serious injuries. Elderly people have a higher risk of falling mainly due to reductions in physical capacities, e.g. visual acuity, vestibular function, reaction time, strength, co-ordination, etc. Furthermore, certain medications commonly prescribed for elderly patients can increase the risk of multiple falls per year.

Hospitals and other health care facilities are very concerned about patient falls for obvious health and liability reasons. They are currently seeking a product that will prevent or detect falls from a hospital bed and will automatically detect when falls occur at other locations in the hospital room or bathroom. Some patented methods for preventing or detecting falls use different mechanical sensors to detect patient movements. However, many of these methods assume that any motion is dangerous, e.g. if the patient gets out of bed, the alarm is sounded at the nurses' station. The nurses and elderly patients need an alarm system which is able to distinguish between normal motion and falling motion.

Tinetti (1988) interviewed 336 people who were 75 yrs or older, living at home in New Haven, Conn. These elderly adults claimed that during the previous 12 months, 32% had one or more falls and 24% had serious injuries including 6% with fractures. In a comparable study, Blake (1988) contacted, 1042 people 65 yrs or older living at home in England. During the preceding 12 months, 35% had one or more falls, due to tipping, dizziness, 6% due to blackouts and other reasons. According to Cumming (1991) some medications increase the risk of multiple falls/yr, e.g. Diazepam (3.7× more likely), Diltiazem (1.8× more likely), Diuretics (1.8× more likely) and Laxatives (2.1× more likely). According to Sutton (1994), falls among elderly hospital patients in England are the most common type of patient accident. Yaretzky (1991) studied a population of 609 hospital patients (447 females + 162 men) in Israel with mean age of 84 yrs. During a 2-month period, 18% of the patients had one or more serious falls. Older patients fell mostly while getting in and out of bed. Yaretzky (1991) concluded that sleeping pills and psychotropic drugs increased the likelihood of falls.

The above statistics indicate that a large number of elderly people fall each year. The next issue to consider is the seriousness of their resulting injuries. According to the National Center for Health Statistics (1995), falls are the second leading cause of fatal accidents in America. In 1995, falls caused 13,986 deaths. During this same period, 43,363 deaths were caused by traffic accidents. Fortunately, most of the elderly patients who fall recover, but their injuries are often very serious. Hazzard (1999) reported the following injury statistics for elderly Americans:

85% of the wrist fractures in elderly adults result from falls

90% of the hip fractures in elderly adults result from falls

40% of the elderly women who have hip fractures don't regain their ability to walk unassisted

20% of the elderly women who have hip fractures don't survive the first year after their injuries.

### DISCLOSURE OF THE INVENTION

In a preferred form of the invention there is provided a bedside patient monitor, for a bed having two sides and two ends, comprising:

an arrangement of video cameras, the arrangement comprising at least one video camera mounted so as to image an area covering each of the two sides;

the video cameras producing an output connected to a computer which runs software which can interpret the output and make a determination from that output when a fall has occurred in an area;

the computer adapted to transmit an alarm in response to the determination.

In other preferred embodiments of the invention there is provided an arrangement comprising a table mounted on wheels, the table supporting one video camera to each side and one camera mounted centrally.

### BRIEF DESCRIPTION OF THE DRAWINGS

FIG. 1 is a schematic diagram of a patient monitoring system according to the teachings of the present invention; and

FIG. 2 is another schematic diagram of the communications network contemplated by the present invention.

### BEST MODE FOR CARRYING OUT THE INVENTION

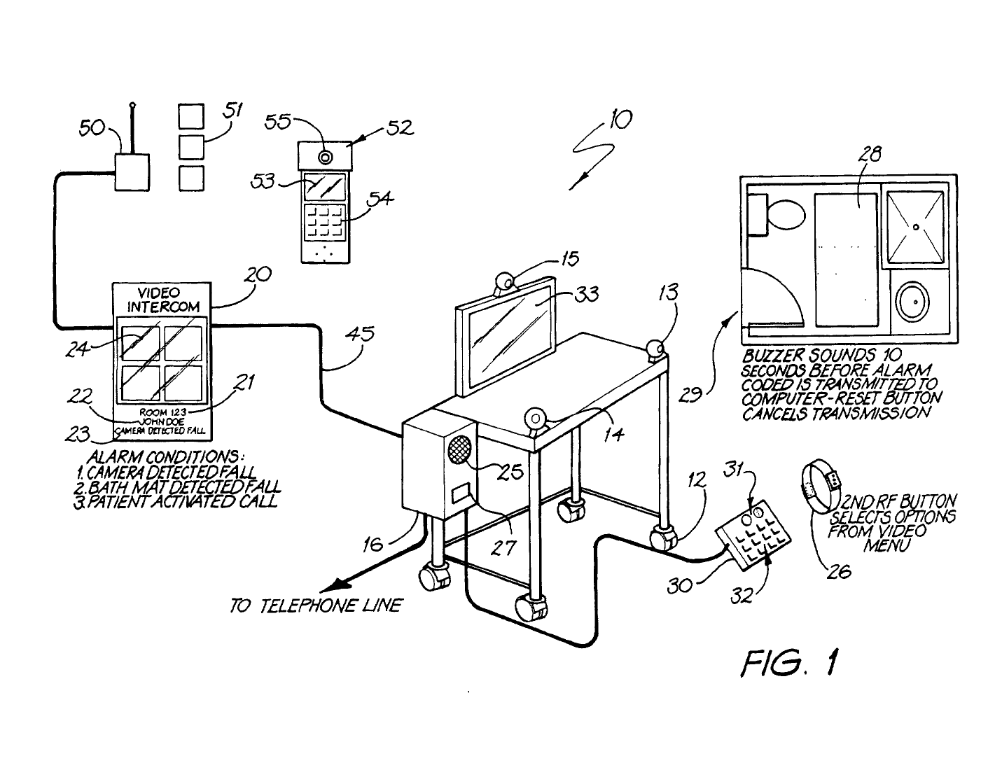

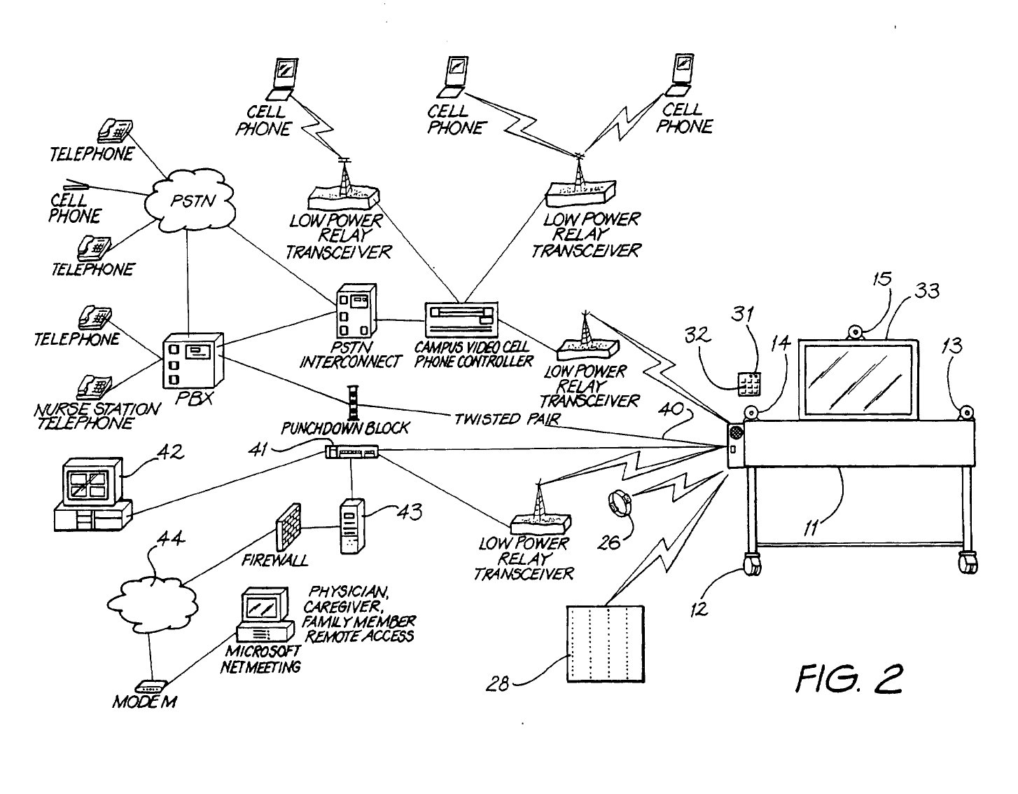

As shown in FIGS. 1 and 2, a preferred embodiment of a system 10 constructed in accordance with the teachings of the present invention comprises an over-the-bed table 11 which is supported by rollers 12. The table 11 supports a right side view camera 13, a left side view camera 14 and a centrally mounted front view camera 15. The output signals of these side mounted video cameras are fed into a bedside computer 16 which may also be mounted on the table 11. Signal processing software within the computer 16 analyses the video images generated from the side cameras 13, 14 and user configurable motion sensing software modules are used to detect a large object which moves towards the floor and remains on the floor for a predetermined and prescribed period of time. As will be explained, the occurrence of this type of triggering event is used to generate one or more outcomes and alarms.

When the computer 16 determines that a patient fall has been detected, the video or still images from each of the three cameras 13, 14 and 15 are automatically transmitted and displayed on a computer monitor located at an attendant's work station. The composite still or video image 20 displayed at the work station allows for the display of the appropriate room number 21, the patient's name 22 and any other relevant information 23. Preferably separate images 24 from each camera 13, 14 and 15 are individually displayed.

The computer is also fed and analyses the video signal emanating from the front view camera 15. The computer 16 also runs motion sensing software which detects when the patient's head is travelling in an upward direction.

When the video image generated by the top centre camera 15 is interpreted by the computer 16 as an attempt by the patient to get out of the bed (such as sustained upward movement of the head image), the video images from that camera 15 the other cameras 13, 14 will be automatically transmitted to the attendant's work station. Simultaneously a voice synthesiser within the computer 16 may be used to generate audible instructions to the patient such as “please get back into the bed”. These messages may be emitted from a speaker 25 mounted on the bedside computer, elsewhere on the table 11 or elsewhere within the patient's room.

If the patient falls at another location within the room, the patient will be able to use a (preferably disposable) radio frequency (RF), portable alarm such as a wrist mounted trigger 26 to send a signal to an RF receiver 27, preferably located within or connected to the bedside computer 16.

The patient's personal RF alarm may incorporate buttons allowing the patient to select options from the video menu on his display 33, as required. In addition, a separate RF alarm signal may be transmitted in response to the output of a pressure sensitive mat 28 located within the patient's bathroom 29. The mat 28 may be subdivided into zones, each with a separate load detecting cell, thereby detecting the difference between a foot and a larger portion of the body resting on the mat.

A control terminal or box 30 may be mounted or removably attached to a bed rail or frame near the patient's head. The control box 30 contains a microphone and speaker 31 as well as a large waterproof keypad 32. The keypad 32 incorporates conventional telephone style keys as well as special function keys which allow the patient to select from a wide variety of optional features. Using the special function keys 32 the patient can:

Initiate an emergency video session with a nurse or attendant on call.

Initiate standard telephone calls.

Operate an overhead light.

Initiate and participate in video calls to and from physicians, friends or relatives via the www or other network.

Activate and use Internet or other e-mail.

Access the hospital or facility's web or intranet pages containing educational information and other menu selections. Activate a snore hiding sleeping aid which detects the fluctuating levels of snoring in the patient's room. A detected noise signal is used to instruct a computer to generate and transmit audible sounds such as ocean waves or rain or wind which mask the sound of the snoring (or other noise). The output volume is synchronised with the changes in the amplitude of the detected snore.

Activate screen saver programme or other video or still images of a soothing nature.

Activate and control other entertainment sources such as CD music, DVD movies, video games, or other audio or visual media.

Configure the entire system to be driven by voice recognition or alternately the RF wrist alarm worn by the patient.

For example, when the “Zero” key of the keypad 32 is activated, a computer monitor or video screen 33, preferably located at the rear and top of the table 11, will enter a menu mode, which will cause the display of information relating to each of the above options. The menu of options displayed on the monitor 33 may be selected through any one of a number of voice recognition techniques, through operation of special purpose buttons on the patient's personal alarm 26 or through further manipulation of the keypad 32.

It will be appreciated that the three primary video cameras 13, 14 and 15 may be supplanted by or assisted by one or more other video cameras which are located in the patient's room but not directly mounted to the table 11.

It will also be appreciated that the video monitor 33 may be used to display images of the attendant or nurse which is assigned to the patient so that the patient and the nurse can communicate and see each other in real time.

It will also be appreciated that any warning signal or warning alarm transmitted by the computer 16 to a remote station or to the attendant's station may be preceded by an audible or visual warning alarm which alerts the patient that an actual alarm is about to be set from the patient's computer 16. The warning alarm may be set for a pre-established short waiting period such as five or ten seconds during which the patient can disable the transmission of the actual alarm by entering appropriate information into the keypad 32, personal alarm 36 or touch screen video monitor 33 (if applicable).

It will be appreciated that the patient's computer 16, regardless of its location, may be connected to any number of network resources. The computer inputs include RF signals from the personal alarm 26 or other wireless devices, keypad strokes from the control keypad 32 which may be transmitted to the computer 16 either via cables or wireless transmissions. The computer's inputs also include the video signals from the cameras 13, 14 and 15 as well as voice signals from the microphone 31. The output of the computer 16 may be delivered through an RF transponder, existing intercom network or conventional telephone lines 40. Video and other signals from the computer 16 may also be transmitted through a local area network (LAN) connection to a central hub 41 which attends to the routing of signals e.g. to either the nurses' station 42, nurses cell phones or, a web server 43 connected to the Internet 44.

Signals can also be communicated through the existing intercom line 45 permitting easy integration with existing communication systems in a healthcare facility. It will also be appreciated that signals transmitted by the computer 16 may be passed on to a high power transceiver 50. The high power transceiver 50 broadcasts to any number of low power transceivers 51 which in turn use radio frequency signals to communicate with any number of pagers, telephones, wireless video or video telephone devices 52 which may be carried by physicians or healthcare professionals. The wireless video/telephone tranceivers 52 preferably include a video display 53 as well as a keypad 54. The video display 53 allows the operator of the unit 52 to receive images transmitted by the cameras 13, 14 and 15 and optionally transmit images of themselves to the patient's monitor 33 through a built-in video camera 55.

1. A bedside patient monitor, for a bed having two sides and two ends, comprising:
an arrangement of video cameras, the arrangement comprising at least one video camera mounted so as to image an area covering one or both sides;
the video cameras producing an output connected to a computer which runs software which can interpret the output and make a determination from that output when a fall or patient movement has occurred in an area;
the computer adapted to transmit an alarm in response to the determination.

2. The monitor of claim 1, wherein:
the arrangement comprises a table mounted on wheels, the table supporting one or more video cameras on each side and one camera mounted centrally.

3. The monitor of claim 2, wherein: the table also supports a video monitor.

4. The monitor of claim 3, further comprising:
a bedside control box, the box connected to the computer and having means for a patient to input control information to the computer.

5. The monitor of any one of claims 1 to 4, further comprising:
a portable RF transmitter, having at least one button and adapted to be carried or worn by a patient and further adapted to transmit a signal when the button is pressed.

6. The monitor of any one of claims 1 to 5, further comprising:
a mat, comprising one or more load cells;
the mat adapted to sense a patient fall as an increase in load and transmit a signal to the computer in response thereto.

7. The monitor of any one of claims 1 to 6, further comprising:
a video monitor located remotely from the patient's bedside and adapted to display, in response to an alarm signal from a patient's monitor, images from the arrangement of video cameras.

8. The monitor of any one of claims 1 to 7, wherein:
the arrangement of video cameras also includes a centre camera adapted to provide an image of a patient's head;
the centre camera providing a signal to the computer;
the computer having software for making a determination that the patient is getting out of bed or rising;
the computer initiating a warning to the patient in response to said determination.

9. The monitor of claim 4, wherein:
the control box further comprises a speaker and microphone.

10. The monitor of any one of claims 1 to 9, wherein:
the computer is adapted to transmit or receive information over an existing intercom line.
